(19) United States
(12) Patent Application Publication
(10) Pub. No.: US 2004/0046753 A1
(43) Pub. Date: Mar. 11, 2004

(54) Card transmitter

(76) Inventors: Chong Ying Goh, Singapore (SG); Bock Huat Tan, Singapore (SG); Chao-Jung Huang, Kaohsiung Shien (TW)

Correspondence Address: TROXELL LAW OFFICE PLLC, SUITE 1404, 5205 LEESBURG PIKE, FALLS CHURCH, VA, 22041, US

(21) Appl. No.: 10/234,523

(22) Filed: Sep. 5, 2002

(51) Int. Cl. G09G 5/00

(52) U.S. Cl. 345/204

(57) ABSTRACT

A card transmitter includes at least a receiving device, a converting module, a transmitting device, and a display. The converting device converts graphic data of an image indicated on the display into code signals, which is then sent to the transmitting device to be transmitted to another card transmitter within a short distance.

### BACKGROUND OF THE INVENTION

This invention relates to a card transmitter, particularly to one transmitting and receiving a graphic data of a card for a short distance.

Cards are an indispensable means for business or social activities, especially those working for expanding business for visiting retailers, distributors, makers, etc. have to carry out with him/her a large number of cards in order to contact with them in case of need. And it is quite inconvenient to find a needed card of a customer from the bundle of cards or a card book.

Now portable electronic appliances have become prevalent, and Palm Desk Assistants (PDA) are used for memorizing data of cards with more convenience than traditional cards. However, the data of cards have to be in advance to be recorded in a PDA before it can be used, impossible to exchange cards with others when meeting them in dealing with business matters. Moreover, a PDA can only store word data, impossible to store graphics such as a personal photo, a company logo, etc for more deep impression for a user to give a businessman.

A card transmitter in the present invention seems to be not yet on the market.

### SUMMARY OF THE INVENTION

The purpose of the invention is to offer a card transmitter transmitting and receiving the graphic and letter data of a card in a short distance.

The card transmitter in the invention includes at least a receiving device, a converting module, a transmitting device, and a display. The receiving device receives transmitted signals and feeds them to the converting module. The converting module converts the received code signals into graphic data, and sends to the display for indicating the graphic and letters on its screen, or converts graphic data of an image on the screen of the display into transmittable code signals to be sent to a receiving device of another card transmitting device. The display is connected to the converting module and shows the graphic and letter data on its screen. The transmitting device transmits the code signals of a card to another card transmitter in a short distance. Therefore, a user can save many cards, not needing to carry with him/her many of them or a heavy card book, only needs a card transmitter in the invention.

### BRIEF DESCRIPTION OF DRAWINGS

This invention will be better understood by referring to the accompany drawings, wherein:

FIG. 1 is a perspective view of a card transmitter in the present invention;

FIG. 2 is a perspective view of the card transmitter in a used condition in the present invention; and,

FIG. 3 is a perspective view of the card transmitter used in another way in the present invention.

### DETAILED DESCRIPTION OF THE PREFERRED EMBODIMENT

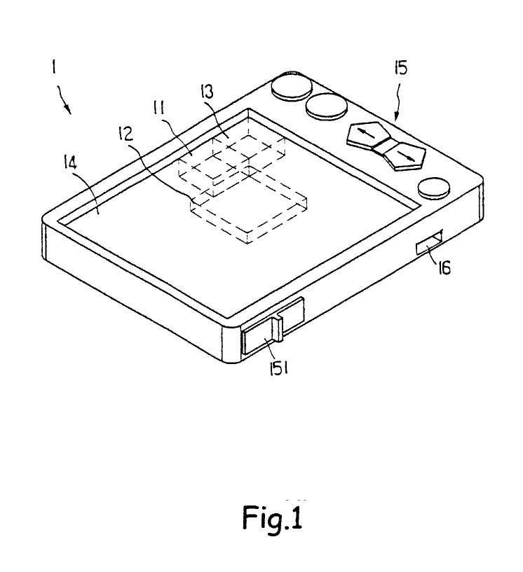

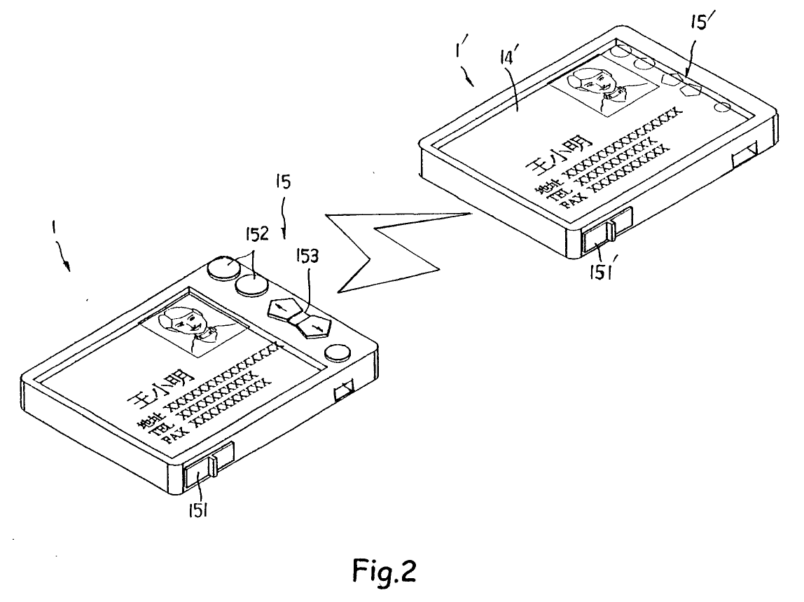

A preferred embodiment of a card transmitter in the present invention, as shown in FIGS. 1 and 2, at least includes a receiving device 11, a converting module 12, a transmitting device 13 and a display 14 as main components combined together.

The receiving device 11 receives code signals transmitted from another card transmitter and feeds them to the converting module 12.

The converting module 12 can either convert code signals coming from the receiving device 11 into graphic data to the display 14 or convert graphic data of an image of a card into code signals and sends them to the transmitting device 13.

The transmitting device 13 transmits code signals coming from the converting module 12 to another card transmitter.

The display 14 is connected to the converting module 12 for receiving graphic data coming from the converting module 12 and indicates them on a screen.

The card transmitter 1 uses the display 14 for indicating the image of a card and the graphic data of the image of the card is converted into code signals by the converting module 12. Then the code signals are sent to the transmitting device 13, which transmits them to another card transmitter 1′ which receives the code signals with its receiving device 11′, and then the receiving device 11′ sends the received code signals to the converting module 12′, which then converts the code signals into graphic data. Then the graphic data are sent to the display 14′, which then indicates the graphic data on its screen, attaining effect of card transmitting.

However, the card transmitter 1 further always includes an operating member 15 consisting of a control switch 151, a receive/send key 152, and a up-and-down key 153 arranged properly on an outer surface of a case of the card transmitter 1. Or as shown in FIG. 2, the display 14′ of the other card transmitter 1′ is a touch-type screen, with the control switch 151 fixed on an outer surface of the case of the card transmitter 1′, with the other keys all formed in an operation soft ware located inside the card transmitter 1′ and controlled with touching as used in a PDA. Then the weight and the size of the card transmitter can be decreased.

The card transmitter can also have written-in telephone numbers and names registered at the telephone company, such as government institutions, hospitals, clinics, commercial companies, other public places, etc. Then a use only looks for the written-n information in the card transmitter for needed telephone numbers to get it quickly, without need of searching a thick telephone directory or asking the number information via telephone, very convenient to use.

Signals used in the card transmitter in the invention may be transmitted by RF (radio frequency), infrared ray, or blue-tooth technology, only suitable for transmission between a short distances, say 3m-5m. As shown in FIG. 1, a connect port 16 such as a SUB (universal serial bus) is further added on an outer surface of the case of the cart transmitter 1, connected to a PC for editing or amending the data of cards, such as personal photos, company logos scanned into a software of the PC. Then the finished data of cards may be sent through the connect port 16 to the card transmitter 1 for a user to carry with himself for transmitting.

The display 14 commonly indicates an image of a user's own card with his/her photo or a company logo. When a user wants to transmit a card to another person, the user handles the receive-and-send key 152 (or by touching in case of a touch-type screen) to transmit through the converting module 12 for converting the graphic data into code signals and sent out by the transmitting device 13. Then another card transmitter 1′ receives the code signals sent out by the card transmitter 1, converting them into graphic data to be fed to the display 14′ for indicating the image of the transmitted card image on its screen. Then the user can dispense with much trouble of carrying out many cards and also save expenditure for cards.

Moreover, though the display 14 is for showing the image of a card on its screen, an advertising mobile picture may be indicated on its screen when possible such as in waiting time. Then press a key can recover the picture of the card at once on the screen.

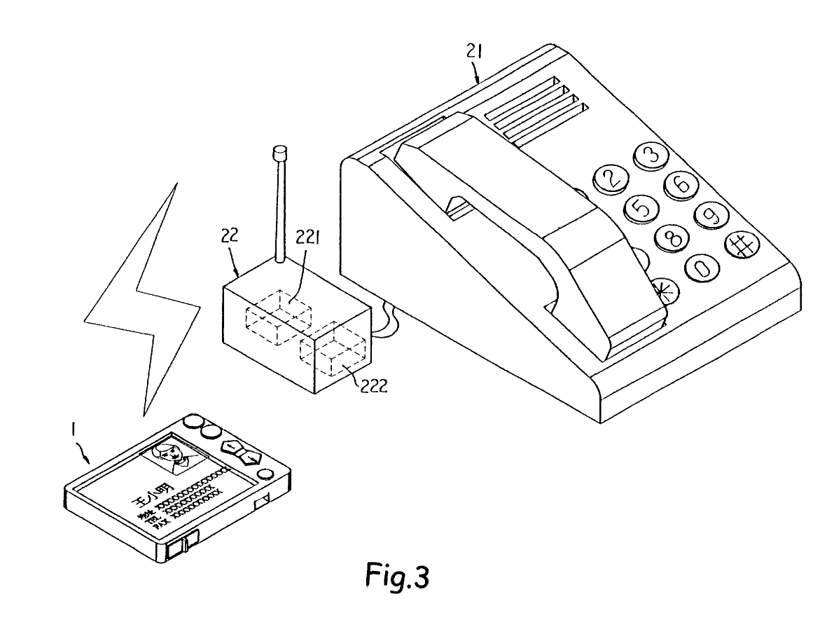

Another example of using the card transmitter is shown in FIG. 3. A control case 22 having a receiving device 221 and a converting module 222 is connected to a common telephone 21. Then the card transmitter 1 can transmit code signals to the control case 22, which receives the code signals by the receiving device 221 and converting the code signals by the converting module 222 to actuate the telephone 21 to dial a number. Then the card transmitter 1 serves as an electronic sound-frequency start telephone directory, and a user picks out a person's card and transmits code signals through the card transmitter 1 to the control case 22 to actuate the telephone so that the telephone automatically switches to automatic dial to attain card transmitting.

As can be understood from the above description, the card transmitter in the invention has the following advantages.

(1) The card transmitter can take place of the traditional card for a user to carry with, dispensing with many personal cards.

(2) The card tranmitter can save much expenditure for printing personal cards and also helpful in environment protection by saving a large volume of paper used for cards.

(3) The card transmitter can have written-in telephone numbers and names registered at the telephone company, such as government institutions, hospitals, clinics, commercial institutions, and public places, etc. Then a user only looks for the written-in information of the card transmitter to get wanted telephone numbers quickly, without need of searching a thick telephone directory or asking the number information, very convenient.

(4) The card transmitter can be used as an electronic sound-frequency start telephone directory, making it needless to put a telephone directory or a card book beside a telephone, and useful by picking out a needed card stored therein for directly dial the number automatically.

(5) The card transmitter can also functions as a calculator, utilizing the control key changed over to a calculator and then entering numerals. Then the monitor may display the result of calculation. Then a user does not need to carry a calculator with him/her.

While the preferred embodiment of the invention has been described above, it will be recognized and understood that various modifications may be made therein and the appended claims are intended to cover all such modification that may fall within the spirit and scope of the invention.

I claim:

1. A card transmitter comprising at least:
A receiving device receiving code signals from another transmitter and sending them to a converting module;
The converting module converting code signals coming from said receiving device into graphic data, and converting graphic data into code signals to be sent to a transmitting device;
The transmitting device transmitting code signals to another card transmitter; and,
A display connected to said converting module to indicate graphic data on its screen.

2. The card transmitter as claimed in claim 1, wherein said card transmitter has a case, and an operating member is fixed on an outer surface of said outer case.

3. The card transmitter as claimed in claim 1, wherein said display has a touch-type screen.

4. The card transmitter as claimed in claim 1, wherein said card transmitter uses wireless radio frequency for transmitting code signals.

5. The card transmitter as claimed in claim 1, wherein said card transmitter uses infrared ray for transmitting code signals.

6. The card transmitter as claimed in claim 1, wherein said card transmitter uses a blue-tooth method for transmitting code signals.

7. The card transmitter as claimed in claim 1, wherein a connect port is fixed on the outer surface of the case of said card transmitter for connecting to a computer.

8. The card transmitter as claimed in claim 1, wherein said card transmitter transmits code signals to a control case connected to a common telephone for automatically dialing a phone number.

9. The card transmitter as claimed in claim 1, wherein said card transmitter has written-in telephone numbers and names registered at the telephone company.

10. The card transmitter as claimed in claim 1, wherein said card transmitter has the function of a calculator.
